(19) United States
(12) Patent Application Publication
(10) Pub. No.: US 2002/0195142 A1
(43) Pub. Date: Dec. 26, 2002

(54) Valve installation apparatus

(75) Inventors: Thomas G. Follett, Red Deer (CA); Joseph D. Trowbridge, Red Deer (CA); E. Stephen Pleadwell, Red Deer (CA); Stewart L. Layden, Red Deer (CA); N. Leon Layden, Red Deer (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Safety Systems International Ltd.

(21) Appl. No.: 10/154,400

(22) Filed: May 22, 2002

(30) Foreign Application Priority Data
May 22, 2001 (CA) 2,348,116

(51) Int. Cl. B25B 27/24

(52) U.S. Cl. 137/315.02

(57) ABSTRACT

A valve installation apparatus includes a vertically adjustable support having a top end and a bottom end. A substantially horizontal arm is provided having a first end and a second end. The first end of the arm is pivotally secured near the top end of the support for movement about a substantially vertical pivot axis. An annular valve support assembly is mounted to the second end of the arm. The valve support assembly has a stationary portion and a rotatable portion. The stationary portion is adapted to mate with and support a valve. The rotatable portion is adapted to mate with a tubular member, so that fluids flowing from the tubular member pass through the valve support assembly to the valve.

### FIELD OF THE INVENTION

The present invention relates to a valve installation apparatus for earth drilling applications, with particular application to the oil and gas industry.

### BACKGROUND OF THE INVENTION

When drilling or servicing oil and gas wells, fluid comes to surface with little, if any, warning. It is, therefore, imperative that a valve be positioned to control well fluids. Delay or improper positioning (cross-threading) of such a valve may endanger the well and personnel working at the well site.

Small valves, which can be defined as valves weighing between 35 to 100 pounds (such as tubing valves), are presently installed by hand. Large valves, which can be defined as valves weighing in excess of 100 pounds are presently installed with the assistance of a winch line. Injuries frequently occur during the course of installation of both small valves and large valves. With small valves, the injuries include back injuries as personnel lift the small valve and fall injuries when personnel lose their footing while carrying the small valve. With large valves the injuries include crushed hands and severed fingers, as personnel attempt to position the large valve which is swinging from the winch line.

### SUMMARY OF THE INVENTION

What is required is a valve installation apparatus suitable for earth drilling applications.

According to the present invention there is provided a valve installation apparatus which includes a vertically adjustable support having a top end and a bottom end. A substantially horizontal arm is provided having a first end and a second end. The first end of the arm is pivotally secured near the top end of the support for movement about a substantially vertical pivot axis. An annular valve support assembly is mounted to the second end of the arm. The valve support assembly has a stationary portion and a rotatable portion. The stationary portion is adapted to mate with and support a valve. The rotatable portion is adapted to mate with a tubular member, so that fluids flowing from the tubular member pass through the valve support assembly to the valve.

The valve installation apparatus, as described above, enables a valve to be rapidly installed on an uppermost tubular member of a string of tubing or drill pipe to control fluids flowing from the well. It has built-in lifting capability, so that personnel do not have to lift the valve into position. The support is vertically adjustable and is, therefore, capable of adjusting to the height of the uppermost tubular member of the string. The valve is secured to and supported by the stationary portion of the valve support assembly, so that alignment is not a problem. The valve support assembly has a rotatable portion. By manually rotating the rotatable portion, the valve support assembly can be rapidly coupled with an uppermost tubular member of a string, so that fluids flowing from the tubular member pass through the valve support assembly to the valve.

Although beneficial results may be obtained through the use of the valve installation apparatus, as described above, even more beneficial results may be obtained when some form of mechanical means is provided for rotating the rotatable portion of the valve support assembly to make a connection with a tubular member. This enables a valve to be positioned without any form of manual handling being required. It is envisaged that one operator can install a valve by manipulating valve installation apparatus using joy stick controls and mechanically rotating the rotatable portion of the valve support assembly when the desired alignment is attained.

Although beneficial results may be obtained through the use of the valve installation apparatus, as described above, depending upon the size of rig, there may not be much room available for the pivoting of the arm. Even more beneficial results may, therefore, be obtained when the arm has a pivotal connection positioned intermediate the first end and the second end. This pivotal connection permits pivotal movement about a substantially vertical pivot axis, thereby enabling the arm to be folded when not in use.

Although there are various drive mechanisms that can be used for rotating the rotatable portion of the valve support assembly, beneficial results have been obtained when a circumferential gear is positioned on the rotatable portion. The circumferential gear engages a drive gear driven by a motor. The motor imparts a rotational force to the drive gear which, in turn, engages the circumferential gear to rotate the rotational portion of the valve support assembly.

Similarly, although there are various drive mechanisms that can be used to vertically adjust the height of the vertically adjustable support, beneficial results have been obtained when the vertically adjustable support is a support column. The support column includes a first section and a second section. The first section is telescopically received within the second section. An expandable hydraulic cylinder is used as means to control the relative telescopic positioning of the first section relative to the second section.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of a valve installation apparatus constructed in accordance with the teachings of the present invention.

FIG. 2 is a top plan view of the arm of the valve installation apparatus illustrated in FIG. 1.

FIG. 3 is a detailed top plan view of the arm of the valve installation apparatus illustrated in FIG. 1.

FIG. 4 is a exploded side elevation view, in section, of the valve support assembly of the valve installation apparatus illustrated in FIG. 1.

FIG. 5 is a top plan view of the valve support assembly of the valve installation apparatus illustrated in FIG. 4.

### DETAILED DESCRIPTION OF THE PREFERRED EMBODIMENT

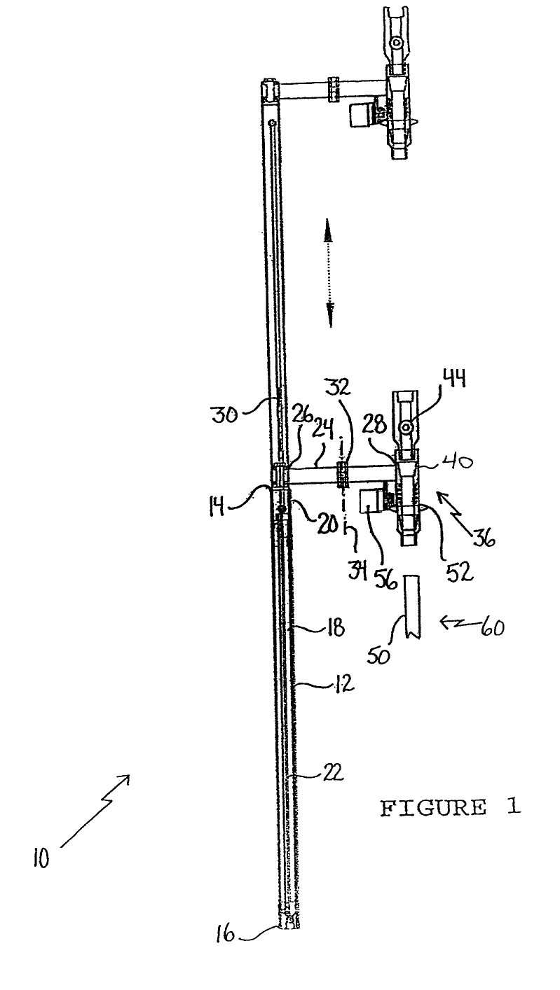

The preferred embodiment, a valve installation apparatus generally identified by reference numeral 10, will now be described with reference to FIGS. 1 through 5.

Structure and Relationship of Parts:

Referring to FIG. 1, there is provided a valve installation apparatus 10 that includes a vertically adjustable support column 12 that has a top end 14 and a bottom end 16. Support column 12 has a first section 18 and a second section 20. First section 18 is telescopically received within second section 20. An expandable cylinder 22 is provided to control the relative telescopic positioning of first section 18 relative to second section 20.

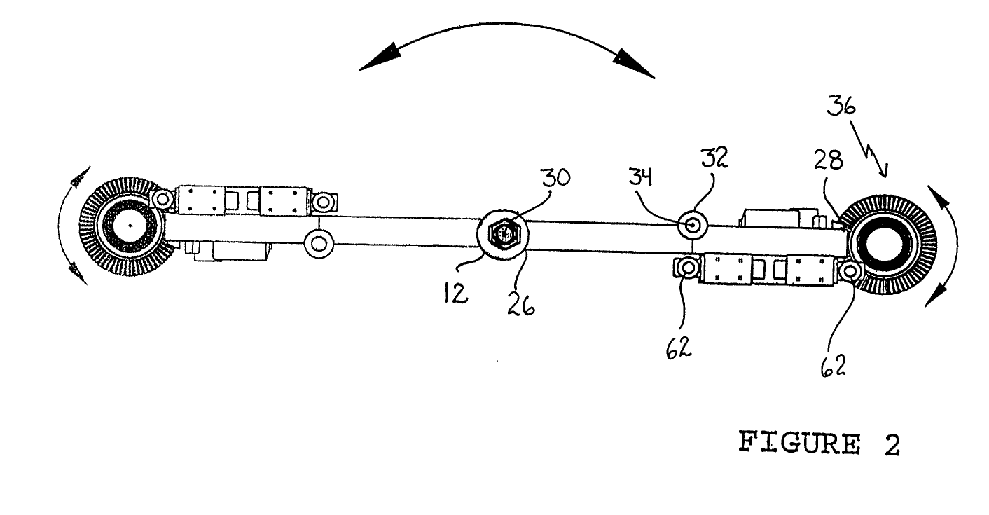

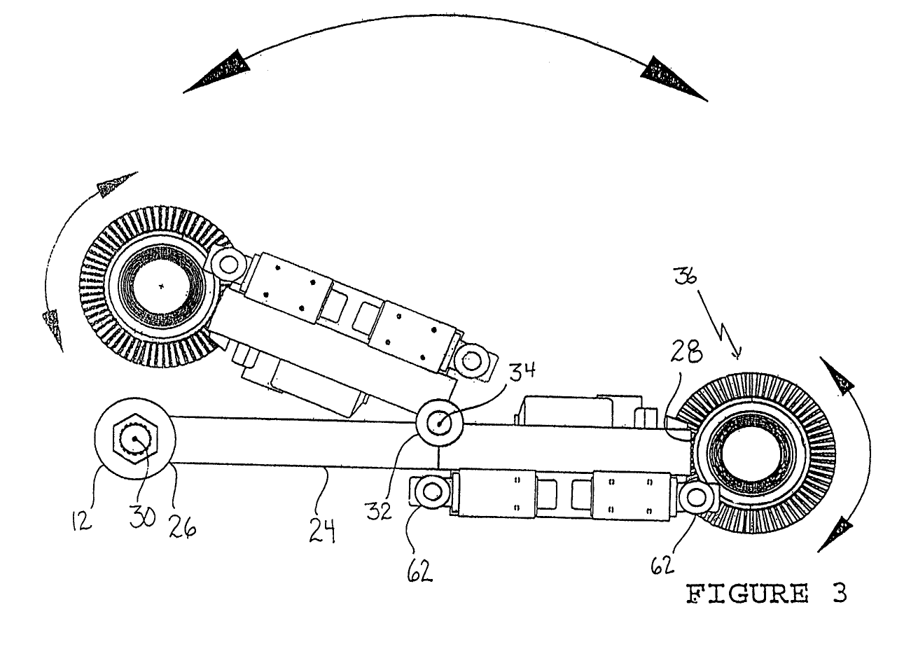

A substantially horizontal arm 24 is provided that has a first end 26 and a second end 28. First end 26 of arm 24 is pivotally secured near top end 14 of support column 12. Referring to FIG. 2, arm 24 is able to pivot about support column 12 on a substantially vertical pivot axis 30. Referring to FIG. 3, arm 24 has a pivotal connection 32 positioned between first end 26 and second end 28. Pivotal connection 32 permits pivotal movement about a substantially vertical pivot axis 34, thereby enabling arm 24 to be folded out of the way when not in use.

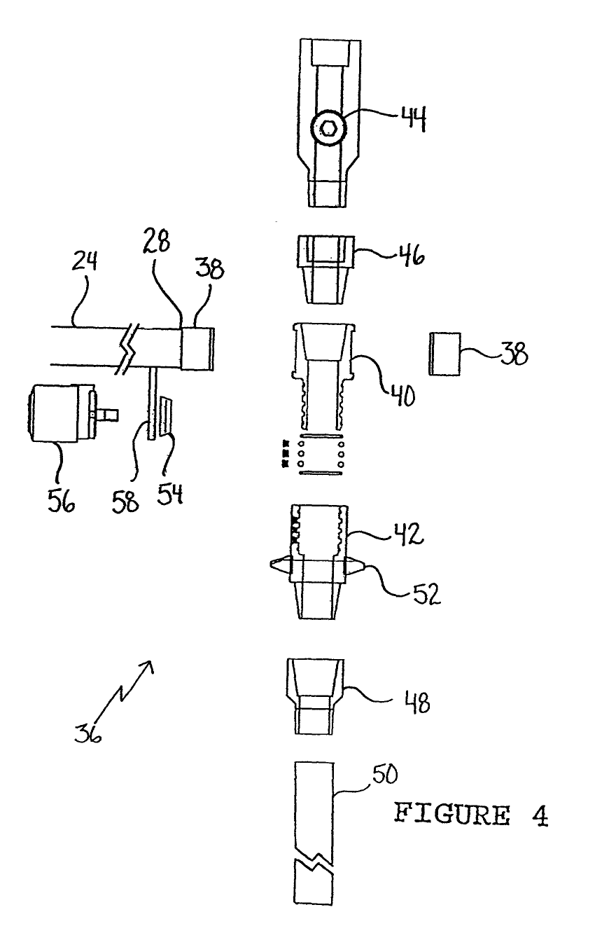

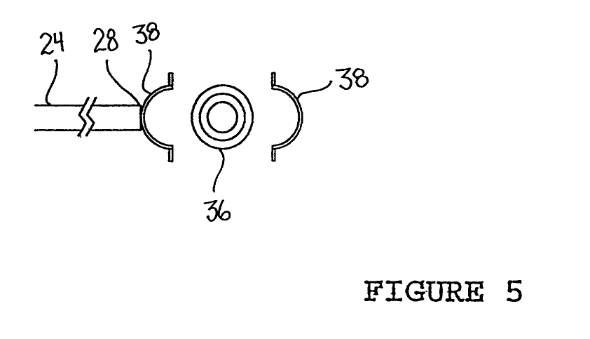

Referring to FIG. 5, an annular valve support assembly 36 is mounted to second end 28 of arm 24 by clamps 38. Referring to FIG. 4, valve support assembly 36 has a stationary portion 40 and a rotatable portion 42. Stationary portion 40 is adapted to mate with and support a valve 44. A threaded adapter 46 is provided for adapting stationary portion 40 to mate with valve 44. A threaded adapter 48 is provided for adapting rotatable portion 42 to mate with a tubular member 50.

A circumferential gear 52 is provided on rotatable portion 42 of valve support assembly 36 that engages a drive gear 54 driven by a motor 56. Motor 56 imparts a rotational force to drive gear 54 which, in turn, engages circumferential gear 52 to rotate rotatable portion 42 of valve support assembly 36, thereby making a connection with tubular member 50 so that fluids flowing from tubular member 50 pass through valve support assembly 36 to valve 44. Motor 56 is supported by a support member 58 depending from second end 28 of arm 24.

Referring to FIG. 2, joystick controls 62 are provided to control all movements.

Operation:

The use and operation of valve installation apparatus 10 will now be described with reference to FIGS. 1 through 5. Referring to FIG. 1, valve installation apparatus 10, as described above, enables valve 44 to be rapidly installed on an uppermost tubular member 50 of a string of tubing or drill pipe 60 to control fluids flowing from the well.

In order to install valve 44, support column 12 is capable of adjusting to the height of uppermost tubular member 50 of string 60. In the illustrated embodiment, expandable hydraulic cylinder 22 is used to control the relative telescopic positioning of first section 18 relative to second section 20 of support column 12, however it will be appreciated that other drive mechanisms are available for vertical adjustment of support column 12.

Referring to FIG. 2, arm 24 is able to pivot about support column 12 on pivot axis 30 for positioning of valve support assembly 36. This movement can either be mechanized or manual. Referring to FIG. 1, valve 44 is secured to and supported by stationary portion 40 of valve support assembly 36, so that alignment is not a problem. Referring to FIG. 4, in the illustrated embodiment, rotational portion 42 is rotated when motor 56 imparts a rotational force to drive gear 54, which in turn engages circumferential gear 52 to rotate rotatable portion 42 of valve support assembly 36. Mechanical rotation of rotational portion 42 allows valve 44 to be positioned without any form of manual handling being required.

Referring to FIG. 2, one operator is able to install valve 44 by manipulating valve installation apparatus 36 using joy stick controls 62 to mechanically adjust the height of support column 12, the positioning of arm 24 and to mechanically rotate rotatable portion 42 of valve support assembly 36 when the desired alignment is attained. As a result, valve support assembly 36 can be rapidly coupled with uppermost tubular member 50 of string 60, so that fluids flowing from tubular member 50 pass through valve support assembly 36 to valve 44.

Referring to FIG. 3, with the use of valve installation apparatus 10, as described above, depending upon the size of rig, there may not be much room available for pivoting of arm 24. In these types of situations, pivotal connection 32 permits pivotal movement about substantially vertical pivot axis 34 so as to enable arm 24 to be folded when not in use.

It will be appreciated that there are various ways that one may configure the controls for valve installation apparatus 10. Valve installation apparatus 10 can be completely automated with controls positioned at the driller's control panel. Valve installation apparatus 10 can be partially manual and partially automated. Valve installation apparatus 10 can be fully automated with controls with valve installation apparatus 10. It is preferred that valve installation apparatus be fully automated with primary controls at the driller's control panel and secondary or redundant controls with valve installation apparatus.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. A valve installation apparatus, including:
a vertically adjustable support having a top end and a bottom end;
a substantially horizontal arm having a first end and a second end, the first end of the arm being pivotally secured near the top end of the support for movement about a substantially vertical pivot axis; and
an annular valve support assembly mounted to the second end of the arm, the valve support assembly having a stationary portion and a rotatable portion, the stationary portion being adapted to mate with and support a valve, the rotatable portion being adapted to mate with a tubular member so that fluids flowing from the tubular member pass through the valve support assembly to the valve.

2. The valve installation apparatus as defined in claim 1, wherein means is provided for rotating the rotatable portion of the valve support assembly.

3. The valve installation apparatus as defined in claim 1, wherein the arm has a pivotal connection positioned intermediate the first end and the second end, the pivotal connection permitting pivotal movement about a substantially vertical pivot axis, thereby enabling the arm to be folded when not in use.

4. The valve installation apparatus a defined in claim 1, wherein the means for rotating the rotatable portion of the valve support assembly includes a circumferential gear on the rotatable portion which engages a drive gear driven by a motor, such that the motor imparts a rotational force to the drive gear which, in turn, engages the circumferential gear to rotate the rotational portion of the valve support assembly.

5. The valve installation apparatus as defined in claim 1, wherein the vertically adjustable support is a support column which includes a first section and a second section, the first section being telescopically received within the second section, means being provided to control the relative telescopic positioning of the first section relative to the second section.

6. A valve installation apparatus, including:
a vertically adjustable support column having a top end and a bottom end, the support column having a first section and a second section, the first section being telescopically received within the second section, an expandable cylinder being provided to control the relative telescopic positioning of the first section relative to the second section;
a substantially horizontal arm having a first end and a second end, the first end of the arm being pivotally secured near the top end of the support for movement about a substantially vertical pivot axis, the arm having a pivotal connection positioned intermediate the first end and the second end, the pivotal connection permitting pivotal movement about a substantially vertical pivot axis, thereby enabling the arm to be folded out of the way when not in use;
an annular valve support assembly mounted to the second end of the arm, the valve support assembly having a stationary portion and a rotatable portion, the stationary portion being adapted to mate with and support a valve, the rotatable portion being adapted to mate with a tubular member; and
a circumferential gear on the rotatable portion of the valve support assembly which engages a drive gear driven by a motor, such that the motor imparts a rotational force to the drive gear which, in turn, engages the circumferential gear to rotate the rotational portion of the valve support assembly, thereby making a connection with a tubular member so that fluids flowing from the tubular member pass through the valve support assembly to the valve.
